(19) United States
(12) Patent Application Publication
(10) Pub. No.: US 2012/0006950 A1
(43) Pub. Date: Jan. 12, 2012

(54) PIVOTING STAND FOR A DISPLAY DEVICE

(76) Inventor: Jesse Vandiver, Oak View, CA (US)

(21) Appl. No.: 12/831,757

(22) Filed: Jul. 7, 2010

(51) Int. Cl. F16M 11/06

(52) U.S. Cl. 248/176.3

(57) ABSTRACT

A stand provides support for a portable display device such as a tablet computer or e-book reader. In one example, the stand includes a leg having a proximal portion and a distal portion and a support member having a proximal portion and a distal portion. A first hinge at the proximal portion of the leg pivotally attaches the leg to the display device, and a first hinge stop is adapted to arrest a pivoting of the leg when the leg pivots at the first hinge to a first angle relative to a rear surface of the display device. A second hinge at the distal portion of the leg pivotally attaches the support member to the leg, and a second hinge stop is adapted to arrest a pivoting of the support member when the support member pivots at the second hinge to a second angle relative to the leg. Here, the support member is configured to support the leg in an open position, such that the distal portion of the support member frictionally engages the rear surface of the display device and the support member is compressed between the rear surface of the display device and the leg.

### BACKGROUND OF THE INVENTION

### Field

The present disclosure relates generally to stands for display devices, and more particularly, to a collapsible stand for supporting a portable display device such as a tablet computer or an e-book reader.

### Background

Recently, portable electronic devices having a form factor dominated by a relatively large display for viewing still or moving images have become highly prominent, with such devices as the Amazon Kindle® ebook reader and Apple iPod® music player in particular garnishing broad publicity for such a form factor. (Kindle is a registered trademark of Amazon Technologies, Inc.; and iPod is a registered trademark of Apple Inc.) Further, a number of manufacturers are anticipating an increase in the popularity of tablet or slate computers having a similar form factor. One advantage of devices having this configuration is that a user has a convenient and portable screen for viewing movies, reading e-books, and/or typing (e.g., e-mail). However, when used for such activities, which take a relatively long time, holding the display device in the user's hand may become somewhat cumbersome and uncomfortable. Thus, many such devices use a stand for floor or tabletop use, such that the user is free to sit or stand more comfortably while viewing a movie, reading an e-book, surfing the Internet, and/or typing. For example, a separate easel or even a charging cradle may hold a display device upright for viewing, or a leg may swing out from the device itself to stand in a leaning position in a fashion similar to a picture frame. The attached stand is notable for its availability without the need to carry a separate easel or cradle. Further, the portable nature of such display devices makes them more susceptible to physical damage. Thus, many covers or cases are available to protect these devices from damage when dropped or from scratches. Moreover, some of these covers include a stand for tabletop support as described above.

However, many modern portable display devices are capable of displaying images in more than one orientation. For example, a rectangular display device may provide for a so-called portrait view, where the vertical dimension is greater than the horizontal dimension, as well as a so-called landscape view, where the device is rotated such that the vertical dimension is less than the horizontal dimension. In this case, while a swing-out leg for standing the display device may be operable in one orientation, it typically will not support the device in the other orientation, collapsing back into a folded position. Although various schemes have been attempted, including interlocking legs, notches for inserting pegs, etc., these setups typically result in a thicker and/or more expensive stand. Thus, an inexpensive stand having a thin profile for supporting a portable display device in multiple orientations, and with multiple incline angles for passive viewing or typing, would find interest in the field.

### SUMMARY

In various representative aspects, the instant disclosure provides for a stand for supporting a portable display device.

In one aspect, the disclosure provides a stand for supporting a display device, including a leg having a proximal portion and a distal portion and a support member having a proximal portion and a distal portion. A first hinge at the proximal portion of the leg pivotally attaches the leg to the display device, and a first hinge stop is adapted to arrest a pivoting of the leg when the leg pivots at the first hinge to a first angle relative to a rear surface of the display device. A second hinge at the distal portion of the leg pivotally attaches the support member to the leg, and a second hinge stop is adapted to arrest a pivoting of the support member when the support member pivots at the second hinge to a second angle relative to the leg. Here, the support member is configured to support the leg in an open position, such that the distal portion of the support member frictionally engages the rear surface of the display device and the support member is compressed between the rear surface of the display device and the leg.

Another aspect of the disclosure provides an apparatus for supporting a display device, including a leg having a proximal portion and a distal portion and a support member having a proximal portion and a distal portion. Here, the apparatus further includes means for pivotally attaching the leg to the display device, means for arresting a pivoting of the leg when the leg pivots at the first hinge to a first angle relative to a rear surface of the display device, means for pivotally attaching the support member to the leg, and means for arresting a pivoting of the support member when the support member pivots at the second hinge to a second angle relative to the leg. Further, the support member is configured to support the leg in an open position, such that the distal portion of the support member frictionally engages the rear surface of the display device and the support member is compressed between the rear surface of the display device and the leg.

Another aspect of the disclosure provides a process for supporting a display device, including pivoting a leg attached to a cover for covering at least a portion of the display device from a closed position folded into a cut-out portion of the cover to an open position extending outward from a rear surface of the display device, arresting the pivoting of the leg at a first angle, pivoting a support member attached to the leg from a closed position folded into a cut-out portion of the leg to an open position extending toward the rear surface of the display device, arresting the pivoting of the support member at a second angle, frictionally engaging a distal tip of the support member, through the cut-out portion of the cover, with the rear surface of the display device at an approximately right angle with the rear surface, and leaning the display device such that a distal tip of the leg supports standing the display device on a surface.

These and other aspects are more fully comprehended upon review of this disclosure.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of one example of a stand for supporting a display device.

FIGS. 2A-2C are perspective views of an example of a stand for supporting a display device showing various configurations for use.

FIGS. 3A-3B are perspective views showing operation of a hinge.

FIG. 4 is a perspective view showing operation of another hinge.

FIG. 5 is another view showing a stand in an open position.

FIG. 6 is a perspective view of an embodiment of a display device for supporting a display device in a default landscape orientation.

FIG. 7 is a view of an embodiment with a shallow angle for typing on a touch-screen display device.

FIG. 8 is a view of the embodiment with a shallow angle oriented in the portrait view.

FIG. 9 is a flow chart illustrating a process for supporting a display device.

Elements and steps in the figures are illustrated for simplicity and clarity and have not necessarily been rendered according to any particular sequence. For example, steps that may be performed concurrently or in different order are illustrated in the figures to help to improve the understanding of various aspects of the disclosure.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. In the context of the present description, when an element is referred to as being “on” another element, it can be directly on the other element or be indirectly on the other element with one or more intervening elements interposed therebetween. Like reference numerals designate like elements throughout the specification.

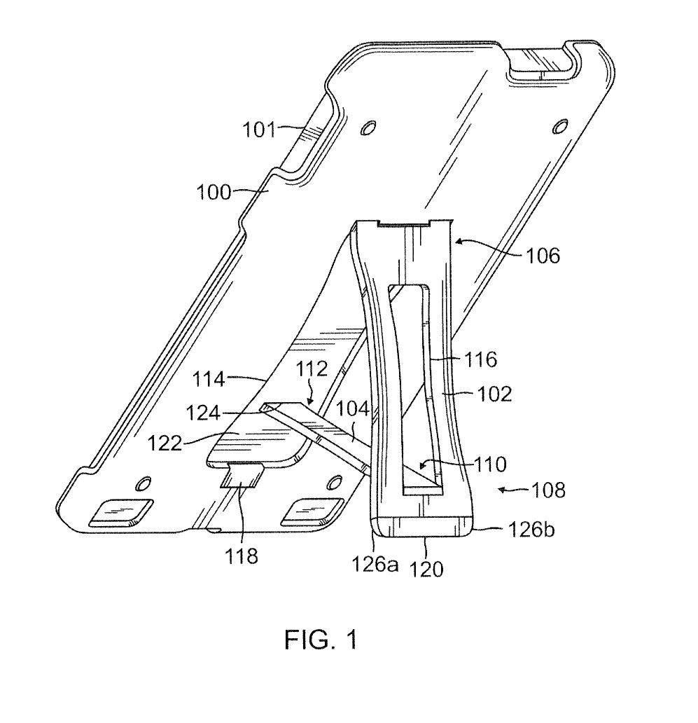

FIG. 1 is an illustration of an exemplary embodiment of a stand for supporting a portable display device 101 according to the instant disclosure. Here, the display device 101 may be a mobile phone, a portable media device, an e-book reader, a television, a tablet or slate computer, or any other device including a screen or display that displays fixed and/or moving images. In another aspect of the disclosure, a display device may include a picture frame for displaying printed photos or digital photos. Those skilled in the art will comprehend upon a full review of the disclosure that the scope of the various embodiments is not limited by the exact nature of the display device 101.

In FIG. 1, the stand includes a case 100, a leg 102, and a support member 104. The leg 102 is attached to the display device 101 by way of a case 100. In various aspects of the disclosure, the leg 102 may be directly or indirectly attached to the display device. That is, the leg 102 may be directly attached to the display device 101, i.e., pivotally attached to a rear panel of the display device itself. In such an example, the case 100 may be omitted. In the illustrated example, the leg 102 is indirectly attached to the display device 101, i.e., pivotally attached to a cover or case 100 that may be fixed or otherwise attached to the display device. In an embodiment including the case 100, the case 100 may be attached to the display device by way of a friction fit, a snap, or any other suitable fastener or securing mechanism. Further, the case 100 may cover the entire display device 100, or any suitable portion of the display device 100.

The leg 102 includes a proximal portion 106 and a distal portion 108. Here, the proximal portion 106 and the distal portion 108 of the leg 102 are defined according to the relative positions of those portions of the leg 102 when the leg 102 is in an open position, as illustrated. That is, the proximal portion 106 is a portion of the leg 102 closer to the rear surface of the display device 101 when the leg 102 is in the open position, and the distal portion 108 is a portion of the leg 102 farther from the rear surface of the display device 101 when the leg 102 is in the open position.

The support member 104 includes its own proximal portion 110 and distal portion 112. Here, the proximal portion 110 and the distal portion 112 of the support member 104 are defined according to the relative positions of those portions of the support member 104 when the support member 104 is in the open position, as illustrated. That is, the proximal portion 110 is a portion of the support member 104 closer to the leg 102 when the support member 104 is in the open position, and the distal portion 112 is a portion of the support member 104 further from the leg 102 when the support member 104 is in the open position.

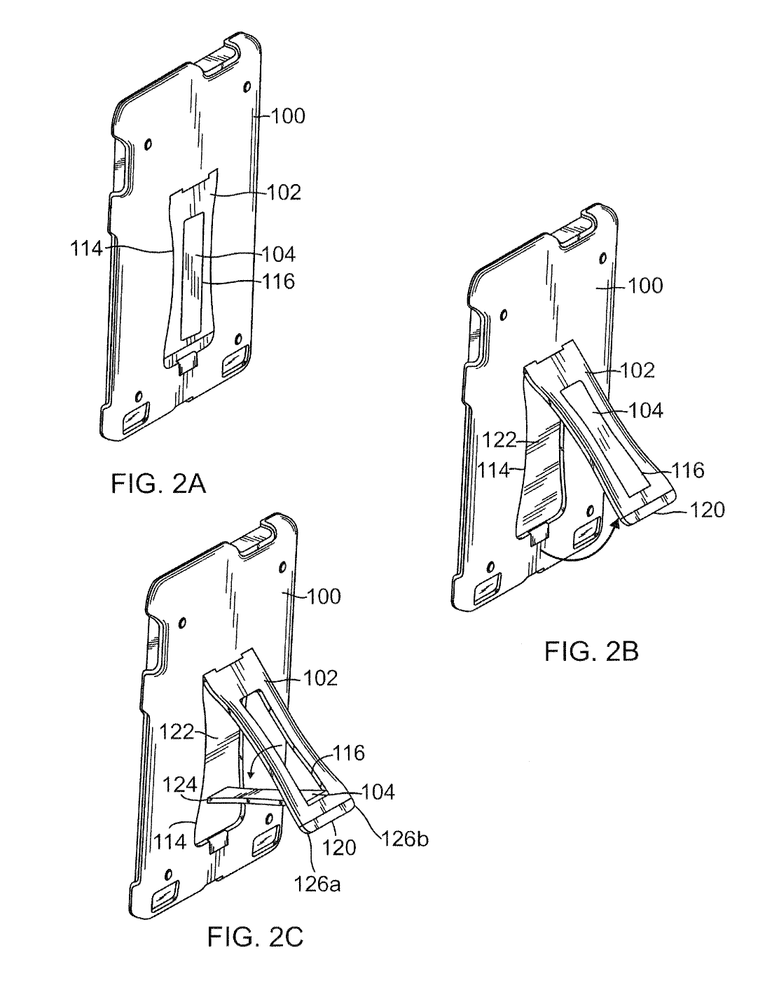

FIGS. 2A-2C illustrate opening the stand in accordance with one example. In FIG. 2A, the stand is in a closed position. Here, the leg 102 and the support member 104 are folded into a closed position, such that they are both substantially flush with the case 100. That is, the case 100 may include a cut-out portion 114, into which the leg 102 may fit when in the closed position. In some examples, the cut-out portion 114 may be omitted, such that the leg 102 and/or support member 104 may not be substantially flush with the case 100. Another example may utilize a recess in the rear surface of the display device or in the case or cover, rather than the cut-out portion 114. However, in embodiments including the cut-out portion 114, the stand as a whole may be thinner than embodiments in which the cut-out portion 114 is omitted.

In FIG. 2B, the leg 102 is illustrated in its open position. In some embodiments, as illustrated in FIG. 1, a notch 118 may facilitate the grasping of the leg 102 to ease the pivoting of the leg 102 from the closed position in FIG. 2A to the open position in FIG. 2B. Here, the support member 104 remains in its closed position. In the position illustrated in FIG. 2B, the stand may properly function to support the display device 101 in the portrait orientation. That is, when the display device 101 is in the portrait orientation, the leg 102 may suitably support the display device when it is leaned back such that a distal tip 120 of the leg 102 contacts a tabletop or other surface. However, if the display device 101 is rotated to the landscape orientation and leaned back, the leg 102 is likely not to suitably support the display device 101. Rather, the leg 102 will likely fold back into the closed position, resulting in the display device 101 laying flat on the tabletop or surface.

In FIG. 2C, the leg 102 is illustrated in its open position, and the support member 104 is illustrated in its open position. That is, either during the opening of the leg 102 or subsequent to having the leg 102 in its open position, the support member 104 may be swung into its open position. In one example, the distal tip 124 of the support member 104 may slide along the rear surface 122 of the display device 101 until the support member 104 reaches its open position, as illustrated. In the open position, the support member 104 supports the leg 102 in its open position. That is, the support member 104 is in compression between the rear surface 122 of the display device 101 and the leg 102, so that a force on the leg 102 that would tend to fold the leg 102 into the closed position would be resisted by the compression of the support member 104.

Having this configuration, the stand may support the display device 101 in its landscape orientation as well as in its portrait orientation. That is, when the display device 101 is rotated into the landscape orientation, the stand provides support for the leaning of the display device 101 by leaning on a corner, e.g., the corner 126a or the corner 126b on the distal tip 120 of the leg 102.

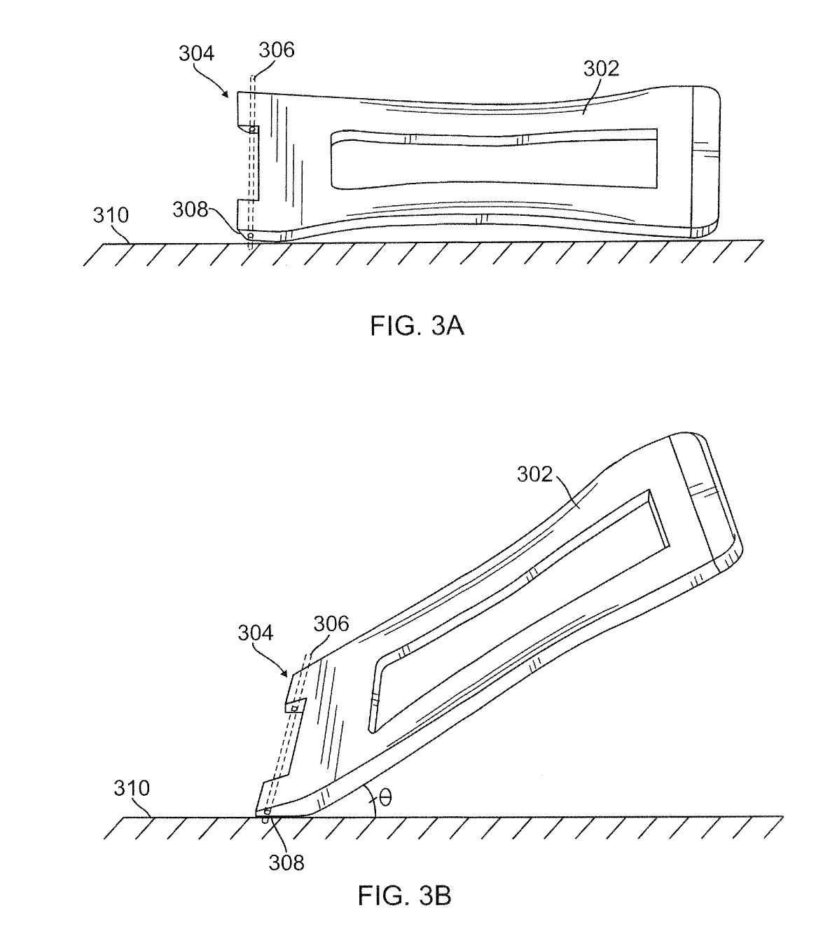

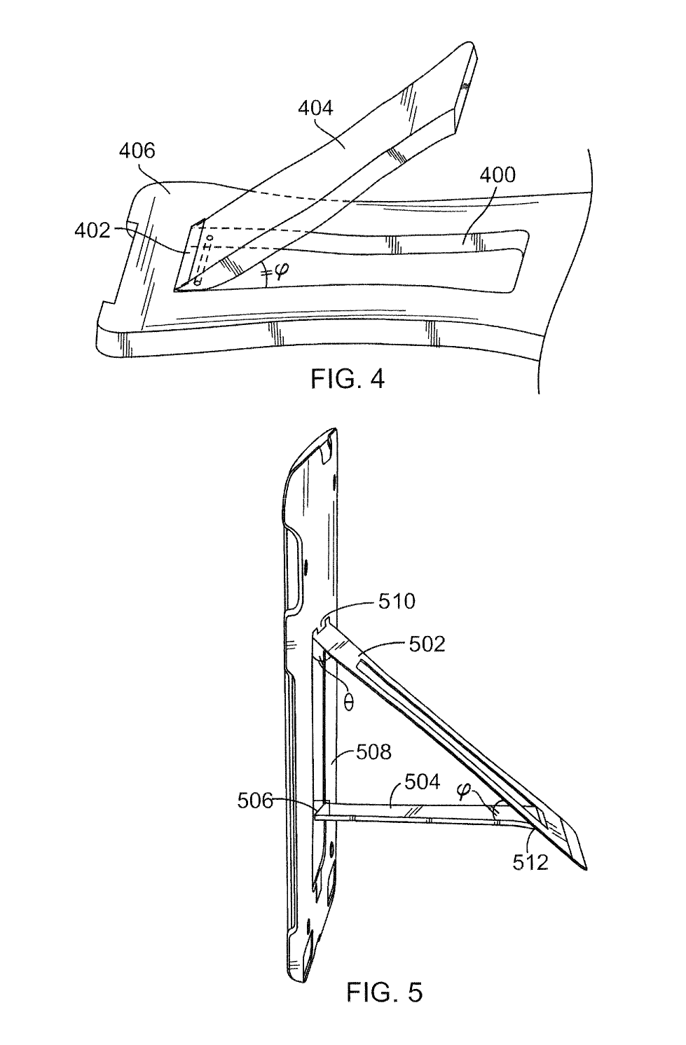

FIGS. 3A-3B illustrate a leg 302 pivotally attached to the display device 101 by a first hinge 304 (e.g., indirectly attached to the display device 101 by being directly attached to the case 100, which is attached to the display device 101). The first hinge 304 includes a pin 306 and a first hinge stop 308. A hinge stop may be any suitable mechanism for arresting the pivoting of a member at the corresponding hinge. For example, in the illustration of FIG. 3A, a surface 308 of the leg 304 is chamfered or beveled to arrest the pivoting of the leg 304 when the beveled surface 308 comes into contact with the surface 310. As another example of a hinge stop, FIG. 4 illustrates a second hinge for pivotally attaching a support member 404 to a leg 406, where an angled surface 402 acts as a second hinge stop for arresting the pivoting of the support member 404 when the support member 404 opens from the leg 406 at a second angle φ relative to the leg 406. Here, a cut-out portion 400 in the leg 406 is configured to accept the support member 404 when it is folded into a closed position, such that the support member is substantially flush with the leg 406 in the closed position. Other examples of suitable hinge stops may include some form of tether for arresting the pivoting of the leg and/or the support member by tension, or a flange or protrusion near the respective hinge for arresting pivoting beyond a certain angle. Of course, those skilled in the art will recognize that these are mere examples from among virtually innumerable hinge stops any suitable one of which may be utilized in accordance with various aspects of the disclosure.

In FIGS. 3 and 4, examples showing the utilization of single pin hinges are illustrated. Those skilled in the art will comprehend that other types of hinges may be utilized within the scope of the instant disclosure, including but not limited to a living hinge, a barrel hinge, a pivot hinge, etc., or any combination thereof.

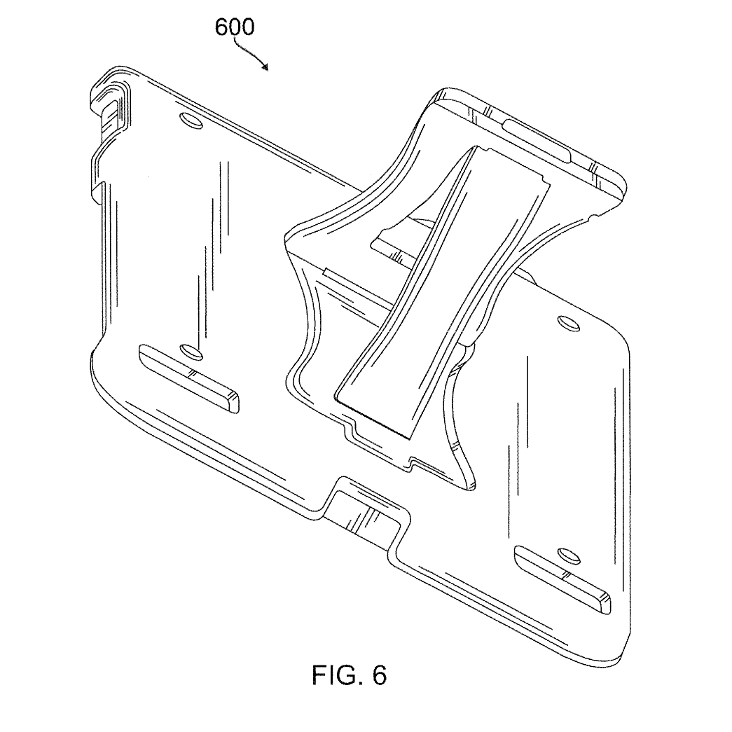

Referring now to FIG. 5, another perspective view is provided of an example of a stand having a leg 502 and a support member 504. In one example, the first angle θ and the second angle φ may be configured such that the distal tip 506 of the support member 504 rests at a substantially right angle with respect to the rear surface 508 of the display device 101. Here, although the angle where the distal tip 506 of the support member is not critical, in an example wherein the angle is less than or equal to a right angle, collapse of the stand may be reduced. That is, as the support member 504 is pivoted towards its open position as illustrated in FIG. 5, the distal tip 506 of the support member 504 should be configured such that it pivots at least to a position where the support member 504 makes a right angle with the rear surface 508 of the display device, or slightly beyond such a position.

Thus, the distal tip 506 of the support member 504 frictionally engages the rear surface 508 of the display device 100. Here, as the support member 504 is engaged in its open position, the compression of the support member 504 may cause a slight bending of the leg 502 in a region between the first hinge 510 and the second hinge 512, until the first hinge stop corresponding to the first hinge 510 and the second hinge stop corresponding to the second hinge 512 arrest the pivoting of the leg 502 and the support member 504, respectively, causing the support member 504 to be held in place by the elastic return movement of the leg 504. Thus, the angle 0 may not be the angle that the entire leg 504 takes with respect to the rear surface 508 of the display device. That is, as the leg flexes to a certain degree in the region between the first hinge 510 and the second hinge 512, the support member 504 may be compressed between the display device and the leg, causing the leg 502 to act as a leaf spring having a strain that resists the flexing motion, thereby holding the support member 504 in its open position by exerting a force toward the rear surface 508 of the display device.

In each of the above illustrations, the stand is shown as having an orientation where the leg opens and closes along a larger dimension of the display device. It may be said that this orientation has a portrait view of the display device as a default orientation, while a landscape view may be called a sideways orientation. Of course, these names are only descriptive, and the stand is configured to function in both orientations as described above. FIG. 6 is a perspective view of an embodiment of a stand 600 oriented such that the landscape view is the default orientation, and the portrait view is the sideways orientation. That is, the leg opens and closes along a shorter dimension of the display device. Those skilled in the art will comprehend that various changes and alterations may be made to the orientation and placement of the stand on the display device without departing from the spirit and scope of the claims.

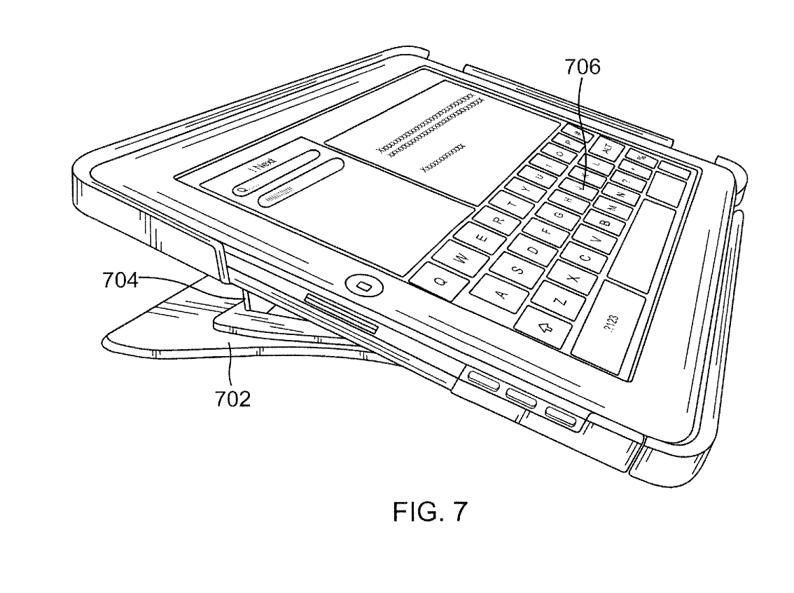

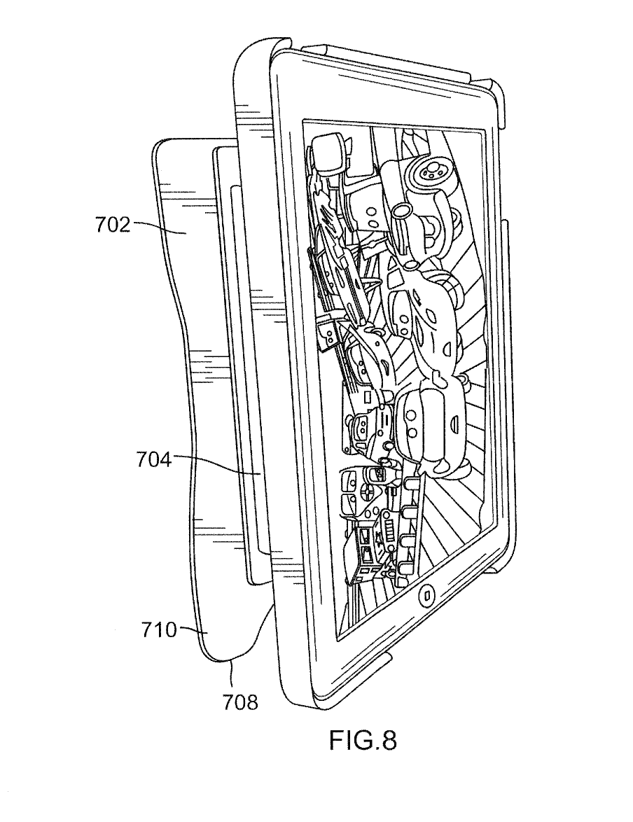

FIG. 7 is a perspective view of an embodiment having a default landscape view and a leg 702 configured to open to a relatively shallow angle. In one example, the leg 702 is configured to open to an angle of about 15° from the rear surface of the display. In the illustrated embodiment, the support member 704 is relatively short, such as to support the leg at the approximately 15° angle. Further, in the embodiment illustrated in FIG. 7, the leg 702 has a width greater than about half the width of the display device. In an alternate embodiment, a plurality of legs having corresponding support members may be utilized as opposed to the relatively wide, single leg. With this configuration, the stand may be utilized to support the display device when leaned at a relatively shallow angle, e.g., suitable for typing on a touch-screen keypad 706. Here, the width of the leg 702 (e.g., being greater than about half the width of the display device) may substantially reduce any rocking or other unwanted movement during typing on the display device. Further, the relatively shallow angle provides an ergonomically comfortable position for typing on the touch-screen keypad 706. While the illustration of FIG. 7 shows the display device leaned in an orientation suitable for typing, those skilled in the art will notice that the leg 702 and support member 704 are likewise capable of standing the display device in its default landscape view, or in its sideways orietation or portrait view, as illustrated in FIG. 8.

That is, FIG. 8 is another view of the embodiment illustrated in FIG. 7, supported in its sideways orientation, that is, a portrait view. In FIG. 8, the leg 702 has a protruding member 708 for supporting the display device. That is, in the illustrated embodiment, because of the relatively short length of the support member 704 causing the relatively shallow angle of the leg 702 (e.g., about 15°), the stand may not be capable of supporting the display device in the sideways orientation unless the leg 702 includes at least a portion extending substantilly near to the edge of the display device. Without this protruding portion 708, or without at least a portion of the leg 702 extending near to the edge of the display device, the center of gravity of the display device may easily pass over the distal tip 710 of the leg 702 causing the display device to fall over. However, with the protruding portion 708, the display device may safely be oriented in its sideways orientation, or as illustrated, the portrait view.

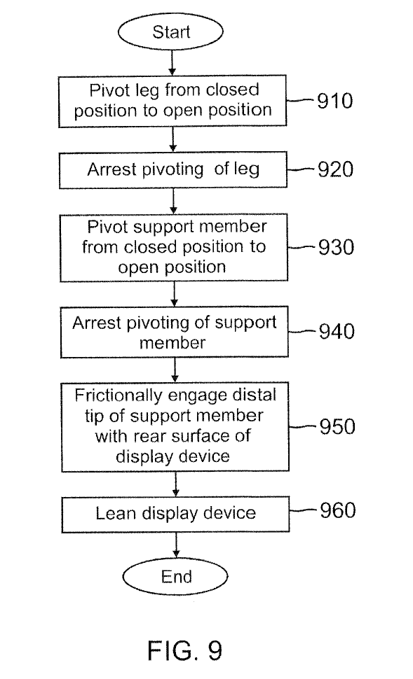

FIG. 9 is a flow chart illustrating a process of supporting a display device in accordance with an exemplary embodiment. In some embodiments the process is performed by a user of a display device, e.g., by hand or with one or more suitable tools. In some embodiments the process is performed by machinery, e.g., during manufacturing of the stand. In some embodiments the process is performed by actuators or other machinery integral with or coupled to a case or the display device. In the illustrated example, in step 910 the process pivots a leg from a closed position to an open position. See, for example, FIG. 2B. Here, the leg may be attached to a cover for covering at least a portion of the display device, and the leg may be folded into a cut-out portion of the cover in the closed position. In step 920, the process arrests the pivoting of the leg, for example, by way of a hinge stop or other means for arresting the pivoting of the leg at a certain angle. In step 930, the process pivots a support member from a closed position to an open position. See, for example, FIG. 2C. Here, the support member may be attached to the leg, and the support member may be folded into a cut-out portion of the leg in the closed position. In step 940, the process arrests the pivoting of the support member, for example, by way of a hinge stop or other means for arresting the pivoting of the leg at a certain angle. In step 950, the process frictionally engages a distal tip of the support member with a rear surface of the display device, for example, by extending through the cut-out portion of the cover and contacting the rear surface of the display device at approximately a right angle with the rear surface. In step 960, the process leans the display device, e.g., such that the leg supports the standing of the display device on a surface such as a tabletop. In various aspects of the disclosure, as discussed above, the leaning 960 of the display device may cause the distal tip of the leg to contact a surface to support the display device in its default orientation; it may cause an edge or corner of the distal tip of the leg to contact the surface to support the display device in its sideways orientation; or, in an embodiment such as illustrated in FIG. 7, the rear surface of the leg may contact the surface to support the display device in its typing orientation.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than merely by the examples described.

1. A stand for supporting a display device, comprising:
a leg having a proximal portion and a distal portion;
a first hinge at the proximal portion of the leg for pivotally attaching the leg to the display device;
a first hinge stop for arresting a pivoting of the leg when the leg pivots at the first hinge to a first angle relative to a rear surface of the display device;
a support member having a proximal portion and a distal portion;
a second hinge at the distal portion of the leg for pivotally attaching the support member to the leg; and
a second hinge stop for arresting a pivoting of the support member when the support member pivots at the second hinge to a second angle relative to the leg;
wherein the support member is configured to support the leg in an open position, such that the distal portion of the support member frictionally engages the rear surface of the display device and the support member is compressed between the rear surface of the display device and the leg.

2. The stand of claim 1, wherein the first angle and the second angle are such that the support member is at approximately a right angle with respect to the rear surface of the display device.

3. The stand of claim 1, wherein the first hinge indirectly attaches the leg to the display device by directly attaching the leg to a cover for covering at least a portion of the display device.

4. The stand of claim 3, wherein the leg is configured to fold into a cut-out portion of the cover.

5. The stand of claim 4, wherein the leg and support member are substantially flush with a rear surface of the cover when closed.

6. The stand of claim 1, wherein the support member is configured to fold into a cut-out portion of the leg.

7. The stand of claim 1, wherein the leg and support member are substantially flush with the rear surface of the display device when closed.

8. The stand of claim 1, wherein the leg has a width greater than about half a width of the display device.

9. The stand of claim 1, wherein the distal portion of the leg comprises a sideways support member extending toward an edge of the display device, the sideways support member configured for supporting the display device when the display device is leaned in a sideways orientation.

10. An apparatus for supporting a display device, comprising:
a leg having a proximal portion and a distal portion;
means for pivotally attaching the leg to the display device;
a first means for arresting a pivoting of the leg when the leg pivots at the first hinge to a first angle relative to a rear surface of the display device;
a support member having a proximal portion and a distal portion;
means for pivotally attaching the support member to the leg; and
a second means for arresting a pivoting of the support member when the support member pivots at the second hinge to a second angle relative to the leg;
wherein the support member is configured to support the leg in an open position, such that the distal portion of the support member frictionally engages the rear surface of the display device and the support member is compressed between the rear surface of the display device and the leg.

11. The apparatus of claim 10, wherein the first angle and the second angle are such that the support member is at approximately a right angle with respect to the rear surface of the display device.

12. The apparatus of claim 10, wherein the means for pivotally attaching the leg is adapted to indirectly attach the leg to the display device by directly attaching the leg to a means for covering at least a portion of the display device.

13. The apparatus of claim 12, wherein the leg is configured to fold into a cut-out portion of the means for covering.

14. The apparatus of claim 13, wherein the leg and support member are substantially flush with a rear surface of the cover when closed.

15. The apparatus of claim 10, wherein the support member is configured to fold into a cut-out portion of the leg.

16. The apparatus of claim 10, wherein the leg and support member are substantially flush with the rear surface of the display device when closed.

17. The apparatus of claim 10, wherein the leg has a width greater than about half a width of the display device.

18. The apparatus of claim 10, wherein the distal portion of the leg comprises means for sideways support extending toward an edge of the display device, the means for sideways support adapted to support the display device when the display device is leaned in a sideways orientation.

19. A process for supporting a display device, comprising:
pivoting a leg attached to a cover for covering at least a portion of the display device from a closed position folded into a cut-out portion of the cover to an open position extending outward from a rear surface of the display device;
arresting the pivoting of the leg at a first angle;
pivoting a support member attached to the leg from a closed position folded into a cut-out portion of the leg to an open position extending toward the rear surface of the display device;
arresting the pivoting of the support member at a second angle;
frictionally engaging a distal tip of the support member, through the cut-out portion of the cover, with the rear surface of the display device at an approximately right angle with the rear surface; and
leaning the display device such that a distal portion of the leg supports standing the display device on a surface.
